(19) United States
(12) Patent Application Publication
(10) Pub. No.: US 2005/0117884 A1
(43) Pub. Date: Jun. 2, 2005

(54) Storage medium storing meta information for enhanced search and subtitle information, and reproducing apparatus

(75) Inventors: Man-seok Kang, Suwon-si (KR); Kil-soo Jung, Hwaseong-si (KR); Jung-wan Ko, Suwon-si (KR); Hyun-kwon Chung, Seoul (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 10/976,364

(22) Filed: Oct. 29, 2004

(30) Foreign Application Priority Data
Oct. 31, 2003 (KR) 2003-77072

(51) Int. Cl. H04N 5/781

(52) U.S. Cl. 386/95; 386/125

(57) ABSTRACT

A storage medium stores meta information of enhanced search and subtitle information, and a reproducing apparatus reproduces the storage medium. The storage medium includes moving-image information, meta information used to provide an enhanced search function of the moving-image information, and subtitle information used to provide subtitles of the moving-image information. The meta information and the subtitle information are recorded in separate files. Therefore, the enhanced search may be performed using various search items, and the subtitle information may be used as subtitles or be referenced by search items. In addition, since the size of the meta information is reduced, data processing is facilitated.

### CROSS-REFERENCE TO RELATED APPLICATIONS

This application claims the priority of Korean Patent Application No. 2003-77072, filed on Oct. 31, 2003, in the Korean Intellectual Property Office, the disclosure of which is incorporated herein in its entirety by reference.

### BACKGROUND OF THE INVENTION

1. Field of the Invention

The present invention relates to the reproduction of a storage medium, and more particularly, to a storage medium storing meta information for enhanced search and subtitle information, and a reproducing apparatus.

2. Description of the Related Art

Audio-visual (AV) data (or a moving-image data stream) composed of video and audio, or subtitles, which are compression-encoded according to a motion picture experts group (MPEG) standard, is recorded on a storage medium such as a DVD. The storage medium also stores additional information, such as encoding properties of the moving-image data stream or the order of reproducing moving-images.

In general, moving-image information recorded on the storage medium is sequentially reproduced based on the additional information. The moving-image information can be reproduced in units of chapters while the AV data is being reproduced.

However, such a conventional storage medium cannot jump to a scene according to a search condition desired by a user and reproduce the scene. In other words, the storage medium does not provide a function for moving to a portion of the AV data according to a search condition (e.g., scene, character, or location) set by the user and reproducing the portion. Therefore, the storage medium cannot offer diverse search functions.

Since moving-image information is compression-encoded on a conventional DVD according to an MPEG 2 standard and multiplexed, it is difficult to manufacture a storage medium that contains meta information used to search for a moving-image. In addition, once a storage medium is manufactured, it is almost impossible to edit or reuse moving-image information or meta information stored in the storage medium.

### SUMMARY OF THE INVENTION

The present invention provides a storage medium storing text-based meta information used to provide an enhanced search function and subtitle information.

The present invention also provides a reproducing apparatus providing the enhanced search function using text-based meta information and subtitle information recorded on a storage medium.

According to an aspect of the present invention, a storage medium stores moving-image information; meta information used to provide an enhanced search function of the moving-image information; and subtitle information used to provide subtitles of the moving-image information. The meta information and the subtitle information may be recorded in separate files. The meta information and the subtitle information may be implemented in a markup language represented by elements and attributes and may be text-based.

According to another aspect of the present invention, a reproducing apparatus reproduces a storage medium storing moving-image information, meta information used to provide an enhanced search function of the moving-image information, and subtitle information used to provide captions of the moving-image information. The apparatus includes a search engine providing the enhanced search function using the meta information and the subtitle information; a subtitle processor producing subtitles of the moving-image information using the subtitle information; and a presentation engine decoding the moving-image information, blending the decoded moving-image information with menu graphics for search purposes and caption data processed by the subtitle processor, and outputting the result of blending.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 illustrates data stored in a storage medium according to an embodiment of the present invention;

FIG. 2 illustrates the configurations of meta information and subtitle information illustrated in FIG. 1 and the relationship between the meta information and subtitle information;

FIG. 3 illustrates the syntax of the meta information according to an embodiment of the present invention;

FIG. 4 is an example of a meta information document structured according to the syntax of the meta information shown in FIG. 3;

FIG. 5 illustrates the syntax of the subtitle information according to an embodiment of the present invention;

FIG. 6 is an example of a subtitle information document structured according to the syntax of the subtitle information shown in FIG. 5;

FIG. 7 illustrates the configuration of a menu provided when a user uses an enhanced search function according to an embodiment of the present invention; and

FIG. 8 is a block diagram of a reproducing apparatus according to an embodiment of the present invention.

### DETAILED DESCRIPTION OF THE PREFERRED EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures.

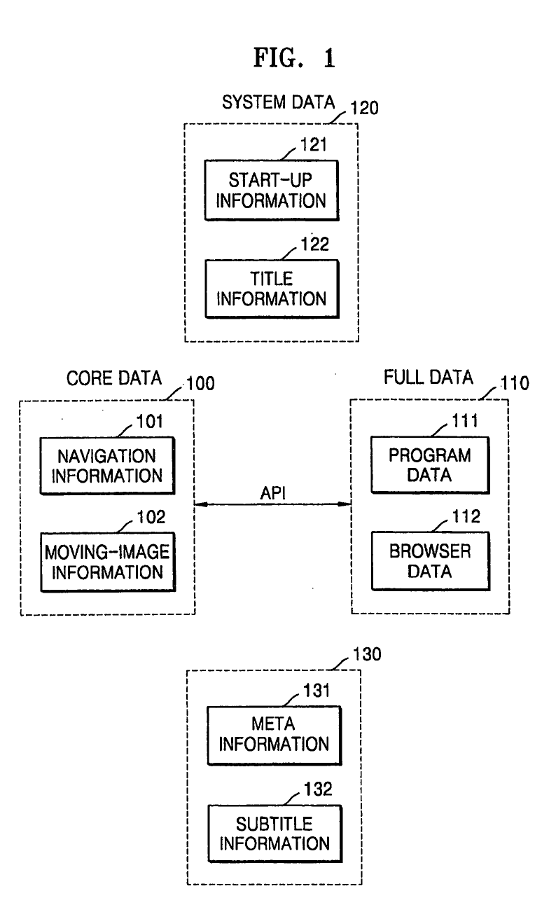

FIG. 1 illustrates data stored in a storage medium according to an embodiment of the present invention. Referring to FIG. 1, the storage medium stores core data 100, full data 110, system data 120, and data for enhanced search 130.

The core data 100 is used to reproduce moving-images and includes moving-image information 102, which is compression-encoded, and navigation information 101 to control the reproduction of the moving-image information 102. The moving-image information 102 includes a clip audiovisual (AV) stream file encoded according to the Motion Pictures Experts Group (MPEG) standard and a clip information file that contains encoding properties of the clip AV stream file and entry point information, wherein the “clip” is a recording unit.

In addition, the moving-image information 102 includes a play list including a plurality of play items, which are reproducing units, each indicating an IN time and an OUT time of the clip information file. The moving-image information 102 may be reproduced with reference to the navigation information 101 stored in the storage medium, and a user may watch a high-quality moving-image such as a movie.

The full data 110 is used to provide extra functions in addition to reproducing moving-images. The full data 110 may include program data 111 for providing interactive functions and/or browser data 112 for retrieving and reproducing information related to a moving-image from a markup document that stores the information. When the additional functions are not used, the full data 110 need not be stored in the storage medium.

The program data 111 may provide additional functions, for example, a game function using moving-images, a function for reproducing a director's commentary while reproducing a portion of a moving-image, a function for displaying additional information while reproducing a portion of a moving-image, or a chatting function while reproducing a moving-image.

The browser data 112 may include commands for retrieving information related to a moving-image from a markup document storing the information and reproducing the information. The commands may be implemented in a markup language and/or an execution script language (for example, as ECMA scripts). Accordingly, information related to a moving-image may be retrieved from a markup document storing the information and reproduced together with the moving-image.

For example, if a movie has been recorded on the storage medium, information related to the movie such as the latest news about actors/actresses starring in the movie, events related to the movie, or updated subtitles that are stored on a web page or in a file, may be retrieved and reproduced together with the movie. The full data 110 may also include other types of data for providing functions other than reproducing moving-images.

The system data 120 is for controlling the reproduction of the core data 100 and/or the full data 110 and includes start-up information 121 and title information 122. The start-up information 121 indicates the position of an object to be first reproduced by a reproducing apparatus. The title information 122 includes entry point information indicating the position of each object to be reproduced.

The data for enhanced search 130 includes meta information 131 and/or subtitle information 132. The meta information 131 is recorded on the storage medium separately from the data described above and is used to provide additional information regarding a moving-image or an enhanced search function. A text-based markup language is used to facilitate the manufacturing of the storage medium and enable the editing and reuse of the meta information 131 after the storage medium is manufactured.

For example, the meta information 131 may include search items such as characters, dialog, sounds, items, and locations based on details of a movie. Accordingly, it is possible to search for only a portion of the moving-image information 102 that meets a desired search condition using the search items and reproduce the portion. Hereinafter, this will be called an enhanced search function.

The subtitle information 132, which is data that contains dialog to be used as caption information, is used as a lookup for search items and is recorded in a separate file. Dialog may be used as a search item included in the meta information 131 as well as subtitles when reproducing moving-images. Therefore, the storage medium stores a file for the subtitle information 132 separately from a file for the meta information 131 to provide dialog as subtitles as well as the meta information 131.

By recording the meta information 131 and the subtitle information 132 on the storage medium as separate files, it is not required to process unnecessary data (that is, it is necessary to extract only dialog from the meta information 131 and parse the extracted dialog), thus facilitating data processing of the meta information 131 and the subtitle information 132. In addition, since dialog information, which is relatively larger than other meta information, is recorded in the file for the subtitle information 132, the size of the file for the meta information 131 may be reduced.

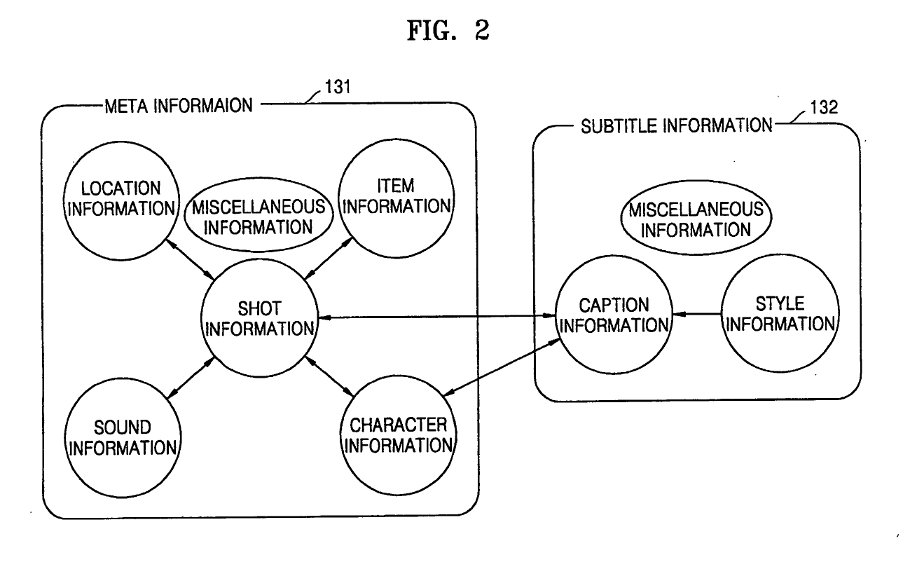

FIG. 2 illustrates the configurations of the meta information 131 and the subtitle information 132 illustrated in FIG. 1 and the relationship between the meta information 131 and the subtitle information 132. Referring to FIG. 2, the meta information 131 may include miscellaneous information, shot information, character information, sound information, location information, and/or item information. The subtitle information 132 may include miscellaneous information, the caption information, and/or style information.

The meta information 131 will now be described in detail. The miscellaneous information provides details of the meta information 131 and may include unique identification information of the meta information 131, language information, and title information of a movie.

In addition, the shot information, the character information, the sound information, the location information, and the item information are grouped and recorded by type to provide the enhanced search function. All of the meta information 131 has reference information of the shot information and may be retrieved using the reference information of the shot information.

The shot information indicates search units into which a movie is divided according to what a producer of the movie desires. For example, a movie may be sectioned into shots based on when a shooting angle of a camera is changed. The shots have unique identification information (shot IDs). The shot information may include a start time and an end time for each shot and may further include an explanation about each shot as well as other information.

The meta information 131 excluding shots refers to shot IDs of shots, which contain search items, such as locations, items, characters, and sounds, as position information present in the moving-image information 102 (AV stream).

The character information concerns characters appearing in the movie. The character information includes unique identification information (character IDs) of characters, shot IDs of shots in which each character appears, the names of the characters, the names of actors/actresses who play the characters, and other additional information.

The sound information concerns a soundtrack and sound effects used in the movie and may include the names of sounds, shot IDs of shots in which each sound is used, and other additional information.

The location information concerns locations where the movie was shot and may include the names of locations, shot IDs of shots in which a setting is used, and additional information.

The item information concerns items appearing in the movie, such as cars and products, and may include shot IDs of shots in which each item appears, and additional information.

The subtitle information 132 will now be described in detail. The miscellaneous information relates to all of the subtitle information 132 and includes unique identification information (ID) of the meta information 131, which refers to the subtitle information 132, and the unique identification information (ID) of the subtitle information 132, the language information, and/or the title information of the movie.

The caption information is text-based data used for subtitles and includes time information regarding when the output of captions starts and stops.

The style information is used to render text captions and includes information regarding caption styles such as fonts, background colors, and the space between two lines.

Like the meta information 131, the subtitle information 132 may also include search items for the enhanced search. Since shot IDs of shots and character IDs of characters reciting dialog corresponding to a caption refer to the caption information, it is possible to search for and reproduce captions used in a particular shot, or dialog or captions for a particular character.

As described above, since the meta information 131 and the subtitle information 132 are recorded in separate text files, the size of each data file is reduced, thus facilitating data processing. In addition, when a reproducing apparatus reproduces a subtitle or provides the enhanced search function, only necessary information needs to be read from the subtitle information 132 or the meta information 131 and executed.

Further, when a reproducing apparatus supporting a network is used, if a producer additionally distributes meta information 131 or subtitle information 132 not recorded on the storage medium over the network, a user may select a file that contains desired information from the meta information 131 or the subtitle information 132 and receive the file.

The meta information 131 is organized according to search item such as shot, location, item, character, and sound. Each of the search items refers to the shot IDs of shots as the position information of the moving-image information of a movie. Therefore, a search engine, which will be described later, may easily create a search menu to be provided to a user, and all of the shots to which a search item designated by the user is referred may be easily searched for.

The caption information of the subtitle information 132 refers to the shot IDs and the character IDs included in the meta information 131. Therefore, the subtitle information 132 may be used as data used for the enhanced search as well as for subtitle data.

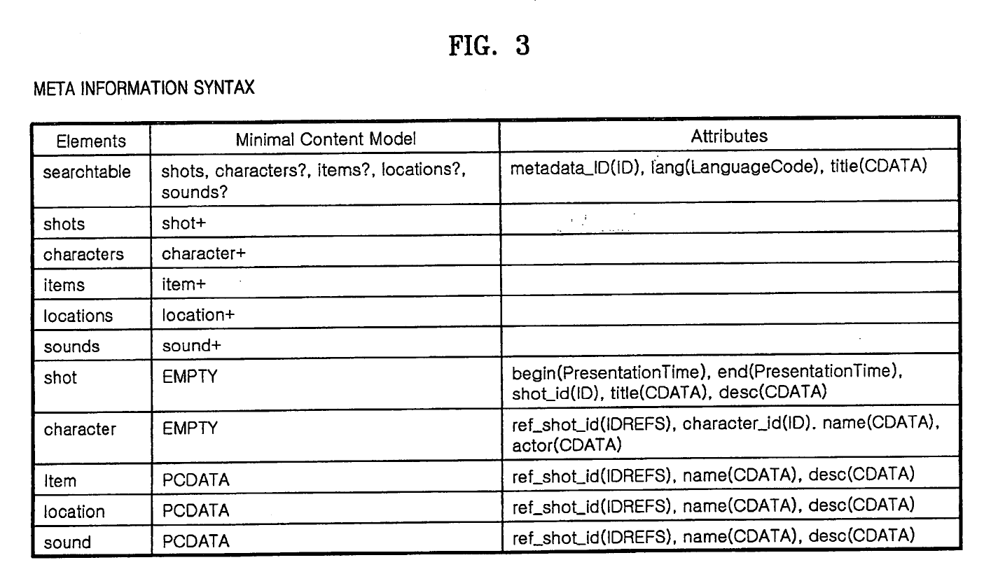

FIG. 3 illustrates the syntax of the meta information 131 according to an embodiment of the present invention. FIG. 3 illustrates examples of definitions of data types to be used in a markup language for the meta information 131. In other words, in FIG. 3, elements and attributes of the meta information 131 are defined. A meta information file may include identification information of the meta information file, a language used, and the title of a movie. The meta information file also includes information regarding a shot element, a character element, an item element, a location element, and a sound element, which are used as search items for the enhanced search. Elements included in the meta information 131 may be grouped.

The syntax for each element and attribute will now be described in detail.

1) Searchtable Element

A searchtable element is the uppermost element of a meta information document (or file), and each meta information document starts with the searchtable element. The searchtable element has attributes such as (a) “metadata_ID” having the unique identification information of the meta information document as an attribute value to distinguish the meta information documents from one another, (b) “lang” having an attribute value indicating a language used to record the miscellaneous information included in the meta information 131, and (c) “title” having an attribute value indicating the title of a moving-image in which the meta information 131 is used.

2) Shots Element

A shots element includes a plurality of shots into which a movie is divided according to intentions of a producer or changes in a camera angle. The shots element includes at least one shot element.

3) Characters Element

A characters element includes information regarding characters of a movie and includes at least one character element.

4) Items Element

An items element includes information regarding items used in a movie and includes at least one item element.

5) Locations Element

A locations element includes information regarding movie locations and includes at least one location element.

6) Sounds Element

A sounds element includes information regarding a soundtrack or sound effects used in a movie and includes at least one sound element.

7) Shot Element

A shot element includes information regarding one of the shots into which a movie is divided and has attributes such as (a) “begin” having a starting time of a shot as an attribute value, (b) “end” having an end time of the shot as an attribute value, (c) “shod_id” having the shot ID as an attribute value to distinguish the shot from other shots, (d) “title” having the title of the shot as an attribute value, and (e) “desc” having a brief description of the shot as an attribute value.

8) Character Element

A character element includes information regarding characters of a movie and has attributes such as (a) “ref_shot_id” having a plurality of shot_ids used to refer to shots in which a character appears as an attribute value, (b) “character_id” having the character ID of the character as an attribute value, (c) “name” having the name of the character as an attribute value, and (d) “actor” having the name of an actor/actress playing the part of the character as an attribute value.

9) Item Element

An item element includes information regarding items appearing in a movie and has attributes such as (a) “ref_shot_id” having a plurality of shot_ids referring to shots in which an item appears as attribute values, (b) “name” having the name of the item as an attribute value, and (c) “desc” having a brief description of the item as an attribute value.

10) Location Element

A location element includes information regarding movie locations and has attributes such as (a) “ref_shot_id” having a plurality of shot_ids referring to shots in which a location is used as attribute values, (b) “name” having the name of the location as an attribute value, and (c) “desc” having a brief description of the location as an attribute value.

11) Sound Element

A sound element includes information regarding a soundtrack or sound effects used in a movie and has attributes such as (a) “ref_shot_id” having a plurality of shot_ids referring to shots in which a sound is played as attribute values, (b) “name” having the name of the sound as an attribute value, and (c) “desc” having a brief description of the sound as an attribute value.

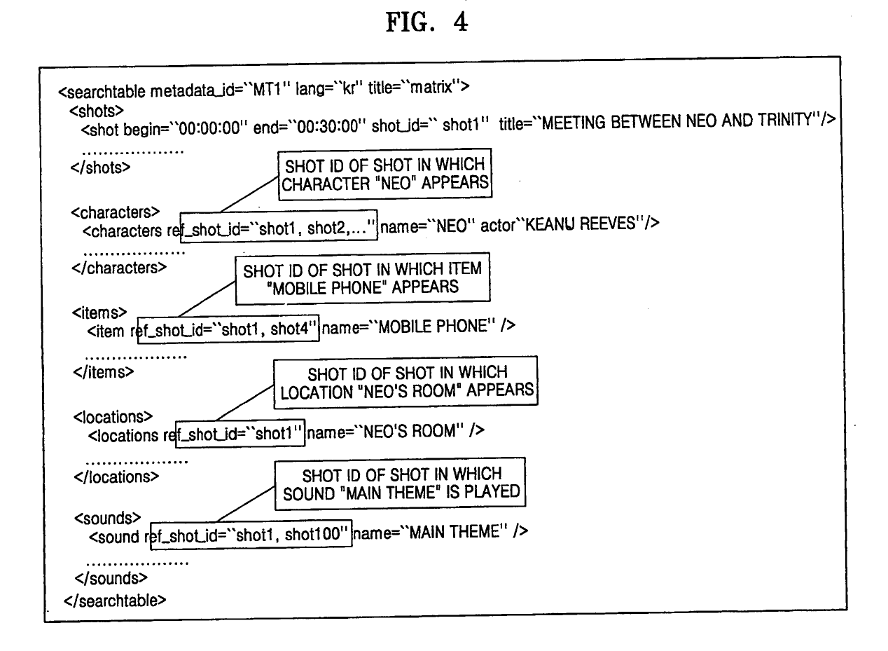

FIG. 4 is an example of a meta information document structured according to the syntax of the meta information 131 shown in FIG. 3. FIG. 4 illustrates an example in which the meta information document is a markup document. As described above, the markup document including the meta information 131 begins with the searchtable element as the first element and designates “MT1” as a unique ID value of the meta information document, “kr” as a language to be used to record additional information, and “matrix” as the title of the moving-image, which uses the meta information 131.

In addition, at least one shot element, character element, item element, location element, and sound element is respectively included in upper elements, in other words, the shots element, the characters element, the items element, the locations element, and the sounds elements. Accordingly, if a user inputs or selects a desired search item, such as a shot element, a character element, an item element, a location element, and a sound element, the user may search for a desired portion of the moving-image information 102 using the desired keyword and reproduce the moving-image information 102 from the desired portion.

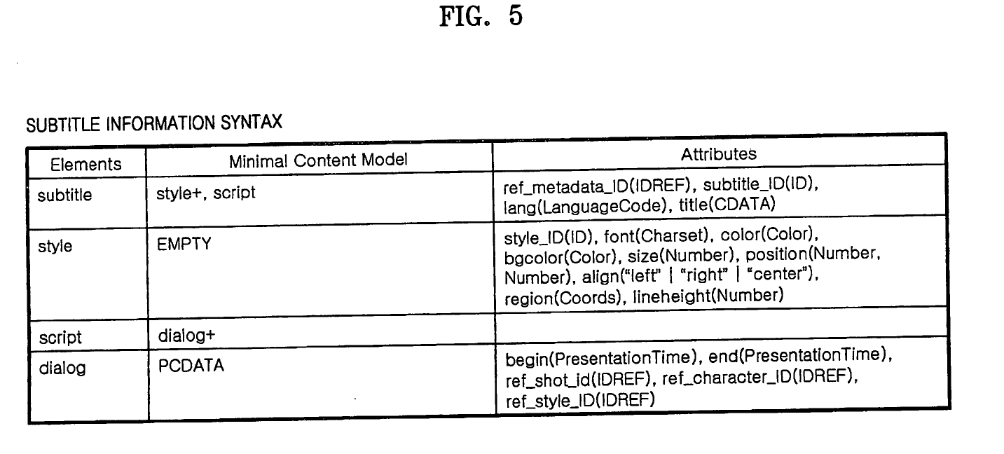

FIG. 5 illustrates the syntax of the subtitle information 132 according to an embodiment of the present invention. FIG. 5 illustrates examples of definitions of data types to be used in a markup language for the subtitle information 132. In other words, in FIG. 5, elements and attributes of the subtitle information 132 are defined. A text-based subtitle information file may include the unique identification information of the meta information document that refers to the subtitle information document, the unique identification information of the subtitle information document, a language used, and the title of a movie. In addition, the subtitle information 132 may include the caption information and the style information to be used to render each caption.

The elements and attributes of the subtitle information 132 will now be described in detail.

1) Subtitle Element

A subtitle element is the uppermost element of a text subtitle document (or file), and each subtitle document starts with the subtitle element. The subtitle element has attributes such as (a) “ref_metadata_ID” having the unique identification information of the meta information document, which refers to the subtitle information document when the subtitle information 132 is used as part of the meta information document, as an attribute value, (b) “subtitle_ID” having the unique identification information of the subtitle information document as an attribute value to distinguish the subtitle information documents from one another, (c) “lang” having a language of subtitles which are displayed on a screen using the subtitle information 132 as an attribute value, and (d) “title” having the title of a moving-image which uses the subtitle information 132 as an attribute value.

2) Style Element

A style element contains the style information used to render the caption information and has attributes such as (a) “style_ID” having the unique identification information of a style as an attribute value to distinguish the style from other styles, (b) “font” having the name of a font of text which is part of the caption information in a dialog element as an attribute value, (c) “color” having a color of the text used for the caption information in the dialog element as an attribute value, (d) “bgcolor” having a background color which is part of caption data in the dialog element as an attribute value, (e) “size” having the size of characters included in the text which is part of the caption data in the dialog element as an attribute value. (f) “position” having an output position of the characters in the text which is part of the caption data in the dialog element as an attribute value, (g) “align” having an alignment method of the text which is part of the caption data in the dialog element as an attribute value, (h) “region” having a region of the screen where the text, which is part of the caption data in the dialog element, will be output as an attribute value, and (i) “lineheight” having the space between two lines of the text, which is part of the caption data in the dialog element, to be output on the screen as an attribute value.

3) Script Element

A script element contains information regarding caption text information and includes at least one dialog element.

4) Dialog Element

A dialog element contains the caption text information displayed on the screen and has attributes such as (a) “begin” having information regarding when the output of caption text starts as an attribute value, (b) “end” having information regarding when the output of the caption text is completed as an attribute value, (c) “ref_shod_id” having a shot ID corresponding to when the dialog element appears as an attribute value, (d) “ref_character_id” having a character ID of a character speaking the dialog element as an attribute value, and (e) “ref_style_ID” having a unique ID of a style element as an attribute value to designate a style to be applied to text data, which is part of the caption data in the dialog element, displayed on the screen.

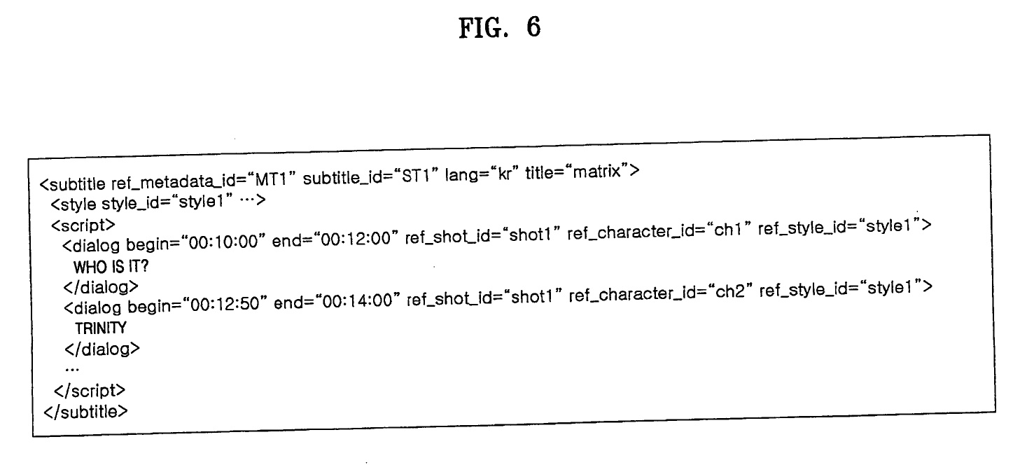

FIG. 6 is an example of a subtitle information document structured according to the syntax of the subtitle information 132 of FIG. 5. Referring to FIG. 6, a subtitle document (or file) including the subtitle information 132 begins with the subtitle element as the uppermost element and designates, as attributes, “MT1” as a unique ID value of the meta information file that will include the subtitle information 132 as part of the meta information 131, “ST1” as a unique ID of the subtitle information 132, “kr” as a language of the caption data to be used as subtitles, and “matrix” as the title of a moving-image that uses the subtitle information 132.

In FIG. 6, the style information is diverse information corresponding to “style_{—}1,” which is a style ID. A plurality of elements are recorded in the script element, and each caption item refers to information regarding start and end times for reproducing a caption, style reference information regarding which style is to be applied, a shot ID that refers to shots included in the meta information 131 in which the caption appears, and a character ID that refers to a character speaking dialog indicated by the caption.

As described above, the subtitle information 132 refers to the meta information file that may include a subtitle by using an attribute such as “ref_metadata_id.” Therefore, the subtitle information 132 itself may be used as part of the meta information 131.

In addition, as a kind of the meta information 131, the subtitle information 132 may be referenced by search items as well as being used as subtitles. Therefore, the subtitle information 132 is recorded in a plurality of files, which makes data processing easier than when all the subtitle information 132 is recorded in one file.

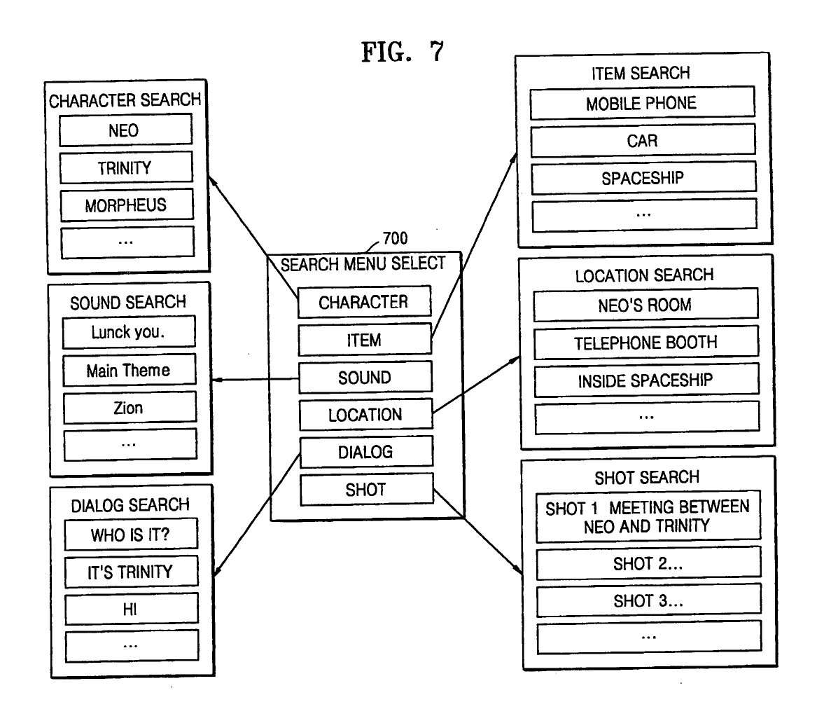

FIG. 7 illustrates the configuration of a menu provided when a user uses an enhanced search function according to an embodiment of the present invention. Referring to FIG. 7, if the user executes an initial search function, the reproducing apparatus provides a Search Menu Select screen 700 to the user through a search engine to be described later. The user may select one of a plurality of search menus provided by the search engine. If the user selects one of the search menus, the search engine forms sub-menus corresponding to the selected menu with reference to the meta information 131 and displays the sub-menus on the screen.

As illustrated in FIG. 7, the sub-menus such as Character Search, Sound Search, Dialog Search, Item Search, Location Search, and Shot Search may be displayed on the screen based on the selection made by the user. In this way, the user may jump to a portion of a movie using a desired keyword and reproduce the movie from the portion.

As described above, the storage medium may store the meta information 131 used to provide the enhanced search function and the subtitle information 132 used as caption data or a search item of the meta information 131 in a text file using a markup language. The meta information 131 and the subtitle information 132 may be recorded in separate files. The subtitle information 132 and meta information 131 described above are exemplary embodiments of the present invention, and may be embodied in various forms.

The storage medium may be easily detachable from the reproducing apparatus and may be an optical disk that may be read by an optical device of the reproducing apparatus. For example, the storage medium may be a CD-ROM, a DVD, or an optical disk that will be developed in the future.

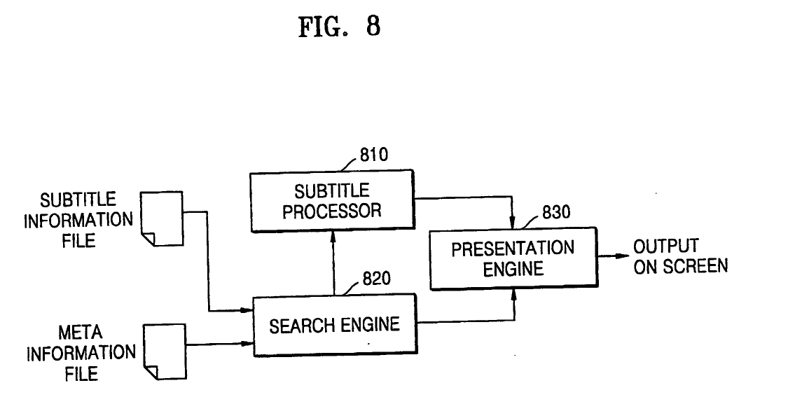

The reproducing apparatus reproducing the storage medium will now be described. FIG. 8 is a block diagram of a reproducing apparatus according to an embodiment of the present invention. FIG. 8 illustrates the configuration of the reproducing apparatus reproducing the storage medium including the text-based subtitle information 132 and the meta information 131. The reproducing apparatus includes a subtitle processor 810, a search engine 820, and a presentation engine 830.

The subtitle processor 810 produces subtitles of the moving-image information 102 using the subtitle information 132. The subtitle processor 810 blends caption information that is rendered using style information to the moving-image information 102.

The search engine 820 provides the enhanced search function using the meta information 131 and the subtitle information 132. Specifically, the search engine 820 parses a meta information file and/or a subtitle information file written in the markup language, checks the parsed file to find syntax errors, and converts the parsed file (or files) into an object in an executable form, thus forming a document object module tree. Then, with reference to the object, the search engine 820 searches for a position in the moving-image information 102 based on at least one of shot, location, character, item, and sound search conditions.

The presentation engine 830 decodes the moving-image information 102 and blends menu graphics used to use the enhanced search function and caption data processed by the subtitle processor 810 to the decoded moving-image information and outputs the result.

Different forms of search and reproduction functions may be provided according to a file contained in the storage medium that will be reproduced by the reproducing apparatus.

First, if there is only a meta information file, the search engine 820 receives the meta information file and checks the meta information file to find syntax errors. If the enhanced search function is requested by a user, the search engine 820 provides an enhanced search menu through the presentation engine 830. In this case, since the subtitle information 132 is not contained in the storage medium, a dialog menu is not provided.

Second, if there is only a subtitle file, the search engine 820 receives the subtitle file and checks the meta information file to find syntax errors. Then, the search engine 820 transmits caption data and style information to the subtitle processor 810, which renders the caption data using the style information and outputs the caption data through the presentation engine 830.

Third, if there are both meta information and subtitle files, the search engine 820 receives both the meta and subtitle files and verifies them. If the caption file is requested by a user, the search engine 820 transmits the caption data and the style information to the subtitle processor 810, which then outputs the caption data through the presentation engine 830. If the enhanced search function is requested by the user, the subtitle information 132 is regarded as part of the meta information 131 based on a reference value of unique identification information of shots and/or characters according to the present invention. Thus, the enhanced search menu including dialog search options may be offered to the user. The present invention may be applied in various forms other than those described above.

As described above, a storage medium according to the present invention provide an enhanced search function using various search items based on text-based meta information and subtitle information recorded thereon.

The subtitle information may be used as caption data or search items. Further, since the meta information and the subtitle information are recorded in separate files, the size of the meta information may be reduced, thus facilitating data processing. In addition, since the meta information and the subtitle information stored in the storage medium are implemented in a text-based markup document, they may be easily edited and reused.

The present invention may also be implemented as computer-readable code on a computer-readable recording medium. The computer-readable recording medium is any data storage device that may store data which may be thereafter read by a computer system. Examples of the computer-readable recording medium include read-only memory (ROM), random-access memory (RAM), CD-ROMs, magnetic tapes, floppy disks, optical data storage devices, and carrier waves (such as data transmission through the Internet).

The computer-readable recording medium may also be distributed over network-coupled computer systems so that the computer-readable code is stored and executed in a distributed fashion.

Although a few embodiments of the present invention have been shown and described, it would be appreciated by those skilled in the art that changes may be made in these embodiments without departing from the principles and spirit of the invention, the scope of which is defined in the claims and their equivalents.

1. A storage medium storing:
moving-image information;
meta information used to provide an enhanced search function of the moving-image information; and
subtitle information used to provide subtitles of the moving-image information,
wherein the meta information and the subtitle information are recorded in separate files.

2. The storage medium of claim 1, wherein the meta information and the subtitle information are implemented in a markup language represented by elements and attributes and are text-based.

3. The storage medium of claim 1, wherein the meta information contains unique identification information of a meta information file.

4. The storage medium of claim 2, wherein the elements of the meta information are grouped by search item.

5. The storage medium of claim 3, wherein the meta information comprises at least one of a shot element, a character element, an item element, a sound element, and a location element.

6. The storage medium of claim 5, wherein each of the elements included in the meta information comprises the unique identification information of the shot element.

7. The storage medium of claim 5, wherein the subtitle information comprises caption information used to provide the subtitles of the moving-image information and style information used to render the caption information.

8. The storage medium of claim 7, wherein the subtitle information comprises information regarding the shot element or character element to facilitate using the caption information as a search item of the meta information.

9. The storage medium of claim 1, wherein the subtitle information contains unique identification information of the meta information containing a subtitle to facilitate using the subtitle information as a search item of the meta information.

10. The storage medium of claim 1, wherein the storage medium is detachable from a reproducing apparatus.

11. The storage medium of claim 10, wherein the storage medium is an optical disk readable by an optical device.

12. A reproducing apparatus reproducing a storage medium storing moving-image information, meta information used to provide an enhanced search function of the moving-image information, and subtitle information used to provide captions of the moving-image information, the apparatus comprising:
a search engine providing an enhanced search function using the meta information and the subtitle information;
a subtitle processor producing subtitles of the moving-image information using the subtitle information; and
a presentation engine decoding the moving-image information, blending the decoded moving-image information with menu graphics for search purposes and caption data processed by the subtitle processor, and outputting a result of the blending.

13. The apparatus of claim 12, wherein the search engine parses a file implemented in a markup language and containing the meta information and/or a file containing the subtitle information to examine syntax, converts the parsed file into an executable object file, and searches for a portion of the moving-image information using at least one of a shot, a location, a character, an item, and a sound as a search item with reference to the converted object file.

14. The apparatus of claim 12, wherein the subtitle processor blends caption information, which is rendered using style information included in the subtitle information, to the moving-image information.

15. The storage medium of claim 1, wherein the storage medium stores core data, full data, system data, and data for enhanced search.

16. The storage medium of claim 1, wherein the core data includes data used to reproduce moving-images and navigation information to control reproduction of the moving-image information.

17. The storage medium of claim 1, wherein moving-image information includes a clip audiovisual stream file encoded according to a Motion Pictures Experts Group standard and a clip information file that contains encoding properties of the clip audiovideo stream file and entry point information, wherein the clip audiovisual stream file is a recording unit.

18. The storage medium of claim 17, wherein the moving-image information includes a play list that includes a plurality of play items, which are reproducing units, each indicating an IN time and an OUT time of the clip information file.

19. The storage medium of claim 15, wherein the full data includes program data to provide interactive functions and/or browser data to retrieve and reproduce information related to a moving-image from a markup document that stores the information.

20. The storage medium of claim 15, wherein the program data provides at least one of a game function using moving-images, a function to reproduce a director's commentary while reproducing a portion of a moving-image, a function to display additional information while reproducing a portion of a moving-image, or a chatting function while reproducing a moving-image.

21. The storage medium of claim 15, wherein the browser data includes commands to retrieve information in a mark-up language or an execution script language, wherein the information is related to a moving-image from a document storing the information and reproducing the information.

22. The storage medium of claim 15, wherein the system data controls reproduction of the core data and/or the full data and includes start-up information and title information, wherein the start-up information indicates a position of an object to be first reproduced by a reproducing apparatus, and the title information includes entry point information indicating a position of each object to be reproduced

23. The storage medium of claim 15, wherein the data for enhanced search includes meta information and/or subtitle information.

24. The storage medium of claim 23, wherein the meta information and subtitle information are stored on the storage medium as separate files.

25. A computer readable medium having recorded thereon computer readable instructions to reproduce a storage medium storing moving-image information, meta information used to provide an enhanced search function of the moving-image information, and subtitle information used to provide captions of the moving-image information, the computer readable instructions comprising:
enhanced searching instructions providing an enhanced search function using the meta information and the subtitle information;
subtitle instructions generating subtitles of the moving-image information using the subtitle information; and
decoding instructions decoding the moving-image information, blending the decoded moving-image information with menu graphics for search purposes and caption data processed by the subtitle processor, and outputting a result of blending.

26. The computer readable medium of claim 25, wherein the enhanced searching instructions parse a file implemented in a markup language and containing the meta information and/or a file containing the subtitle information to examine syntax, convert the parsed file into an executable object file, and search for a portion of the moving-image information using at least one of a shot, a location, a character, an item, and a sound as a search item with reference to the converted object file.

27. The computer readable medium of claim 25, wherein the subtitle instructions blend caption information, which is rendered using style information included in the subtitle information, to the moving-image information.
